(19) United States
(12) Patent Application Publication
(10) Pub. No.: US 2018/0162113 A1
(43) Pub. Date: Jun. 14, 2018

(54) METHOD FOR MANUFACTURING LAMINATED FILM AND APPARATUS FOR MANUFACTURING LAMINATED FILM

(71) Applicant: FUJIFILM Corporation, Tokyo (JP)

(72) Inventors: Shuto KONO, Kanagawa (JP); Kyohisa UCHIUMI, Kanagawa (JP)

(73) Assignee: FUJIFILM Corporation, Tokyo (JP)

(21) Appl. No.: 15/892,637

(22) Filed: Feb. 9, 2018

Related U.S. Application Data
(63) Continuation of application No. PCT/JP2016/072783, filed on Aug. 3, 2016.

(30) Foreign Application Priority Data
Aug. 11, 2015 (JP) 2015-158829

(51) Int. Cl. B32B 37/15; B32B 27/08; B32B 37/10; B32B 37/00; B32B 37/06; B32B 41/00; B32B 27/36

(52) U.S. Cl. CPC B32B 37/15; B32B 27/08; B32B 37/10; B32B 2037/243; B32B 37/06; B32B 41/00; B32B 27/36; B32B 37/0053

(57) ABSTRACT

A method for manufacturing a laminated film and an apparatus for manufacturing a laminated film obtains a laminated film including a cured layer having a uniform thickness at the time of manufacturing a laminated film obtained by sandwiching the cured layer obtained by curing an actinic ray curable-type resin between two sheets of films. Steps include forming a coating film of a coating solution containing an actinic ray curable-type resin on the surface of a first film while continuously transporting the first film, laminating a second film on the coating film while continuously transporting the second film, and forming a cured layer of the coating film by irradiating the coating film with an actinic ray while continuously transporting the coating film by sandwiching the coating film between the first film and the second film, in a state where the first film is being wound around a backup roller.

### CROSS-REFERENCE TO RELATED APPLICATIONS

This application is a Continuation of PCT International Application No. PCT/JP2016/072783 filed on Aug. 3, 2016, which claims priority under 35 U.S.C. § 119(a) to Japanese Patent Application No. 2015-158829 filed on Aug. 11, 2015. The above application is hereby expressly incorporated by reference, in its entirety, into the present application.

### BACKGROUND OF THE INVENTION

### 1. Field of the Invention

The present invention relates to manufacturing of a laminated film obtained by sandwiching a cured layer between films.

### 2. Description of the Related Art

In various devices including optical elements, display devices such as a liquid crystal display or an organic EL display, semiconductor devices, thin-film solar cells, and the like, various films such as a gas barrier film, a protective film, an optical filter, an antireflection film, and a quantum dot film are used.

As these films, laminated films having a constitution in which a plurality of films or layers performing intended functions are laminated are known.

For example, a quantum dot film has a constitution in which a quantum dot layer obtained by dispersing quantum dots in a resin and performing curing is sandwiched between two sheets of films. As the films between which the quantum dot layer is sandwiched, in order to prevent the quantum dots from deteriorating due to oxygen or the like, a gas barrier film or the like is used.

As methods for manufacturing a laminated film, various methods are suggested.

For example, JP1998-11404 A (JP-1110-114041A) describes a method for manufacturing a laminated film, in which a cured layer is formed by coating a molding substrate with an electron beam curable-type resin composition and curing the composition while a coating film (coating layer) formed of the electron beam curable-type resin composition is formed on a sheet-like substrate; the molding substrate and the sheet-like substrate are laminated in a state where the cured layer and the coating film face each other; the laminate is irradiated with electron beams and the like such that the coating film is cured and formed into a cured layer; and then a laminated film in which the two cured layers and the sheet-like substrate are laminated is peeled from the molding substrate.

In JP1998-114041A (JP-H10-114041A), as a molding support, a cylindrical drum, a molding film, and the like are exemplified.

JP2011-225002A describes a method for manufacturing a laminated film, including a coating step of coating the surface of a first sheet sent from supply means with an ultraviolet curable resin, a first curing step of partially curing the ultraviolet curable resin by first ultraviolet curing means, a pressure bonding step of bonding a second sheet sent from the supply means to the first sheet by pressure bonding means including a coater controlling thickness such that a long laminate is obtained, and a second curing step of further curing the ultraviolet curable resin by second ultraviolet curing means, in which the irradiation amount of the ultraviolet ray from by the second ultraviolet curing means is made larger than the irradiation amount of the ultraviolet ray from the first ultraviolet curing means.

### SUMMARY OF THE INVENTION

According to the aforementioned manufacturing methods, by using so-called roll-to-roll processing, a laminated film can be manufactured with excellent production efficiency by sandwiching a cured layer between films.

However, in the methods for manufacturing a laminated film of the related art that are described in JP1998-114041A (JP-H10-114041A) and JP2011-225002A, the thickness of the cured layer easily becomes uneven. Therefore, for the uses requiring the cured layer to have a highly uniform thickness, it is difficult to manufacture an intended laminated film.

The present invention is for solving the aforementioned problems of the techniques of the related art, and an object thereof is to provide a method for manufacturing a laminated film and an apparatus for manufacturing a laminated film that make it possible to manufacture a laminated film including a cured layer having a highly uniform thickness by significantly inhibiting thickness unevenness of the cured layer at the time of manufacturing a laminated film obtained by sandwiching the cured layer between films.

In order to achieve the aforementioned object, the present invention provides a method for manufacturing a laminated film, comprising a coating film forming step of forming a coating film by coating a surface of a first film with a coating solution containing an actinic ray curable-type resin while continuously transporting the first film, a laminating step of laminating a second film on the coating film while continuously transporting the second film, and a curing step of curing the coating film by irradiating the coating film with an actinic ray while continuously transporting the coating film by sandwiching the coating film between the first film and the second film such that a cured layer is formed, in which all the coating film forming step, the laminating step, and the curing step are performed in a state where the first film is being wound around a backup roller.

It is preferable that in the method for manufacturing a laminated film of the present invention, in the laminating step, the second film is laminated on the coating film, in a state of being wound around a bonding roller separated from the first film.

It is preferable that a distance between the bonding roller and the backup roller is equal to or greater than the sum of a thickness of the first film, a thickness of the coating film, and a thickness of the second film.

It is preferable that a distance between the bonding roller and the backup roller is less than the sum of the thickness of the first film, the thickness of the coating film, and the thickness of the second film.

It is preferable that a gap between the backup roller and the bonding roller is controlled such that a film thickness of the coating film is controlled by the second film wound around the bonding roller.

It is preferable that a tension applied to the second film is equal to or lower than 100 N/m.

it is preferable that in the curing step, the actinic ray curing the coating film is an electromagnetic wave having a half-width of an intensity distribution with respect to a wavelength of equal to or smaller than 100 nm.

It is preferable that a surface temperature of the backup roller is controlled within a range of 15° C. to 55° C.

It is preferable that provided that a tension applied to the first film is T1, a Young's modulus of the first film in a transport direction is E1, a thickness of the first film is d1, a tension applied to the second film is T2, a Young's modulus of the second film in a transport direction is E2, and a thickness of the second film is d2, T1, E1, d1, T2, E2, and d2 satisfy the following expression.

0.05<[T2/(E2×d2)]/[T1/(E1×d1)]<20

The present invention also provides an apparatus for manufacturing a laminated film, comprising a backup roller, transport means for continuously transporting the first film by winding the first film around the backup roller, coating film forming means which is disposed facing the backup roller and forms a coating film by coating the first film wound around the backup roller with a coating solution containing an actinic ray curable-type resin, laminating means which is disposed facing the backup roller on a downstream side of the coating film forming means in a transport direction of the first film and laminates the second film on the coating film while continuously transporting the second film, and curing means which is disposed facing the backup roller on a downstream side of the laminating means in the transport direction of the first film and irradiates a laminate, in which the coating film is sandwiched between the first film and the second film, with an actinic ray.

According to the present invention, it is possible to manufacture a laminated film including a cured layer having a highly uniform thickness by significantly inhibiting thickness unevenness of the cured layer at the time of manufacturing a laminated film obtained by sandwiching a cured layer between films.

### BRIEF DESCRIPTION OF THE DRAWINGS

FIG. 1 is a view schematically showing an example of an apparatus for manufacturing a laminated film of the present invention.

FIG. 2 is a partially enlarged view of FIG. 1.

FIG. 3 is a view schematically showing another example of the apparatus for manufacturing a laminated film of the present invention.

FIG. 4 is a partially enlarged view of FIG. 3.

### DESCRIPTION OF THE PREFERRED EMBODIMENTS

Hereinafter, a method for manufacturing a laminated film and an apparatus for manufacturing a laminated film of the present invention will be specifically described based on suitable examples shown in the attached drawings.

The following constituents will be described based on typical embodiments of the present invention in sonic cases, but the present invention is not limited to the embodiments.

In the present specification, a range of numerical values described using “to” means a range including the numerical values listed before and after “to” as a lower limit and an upper limit.

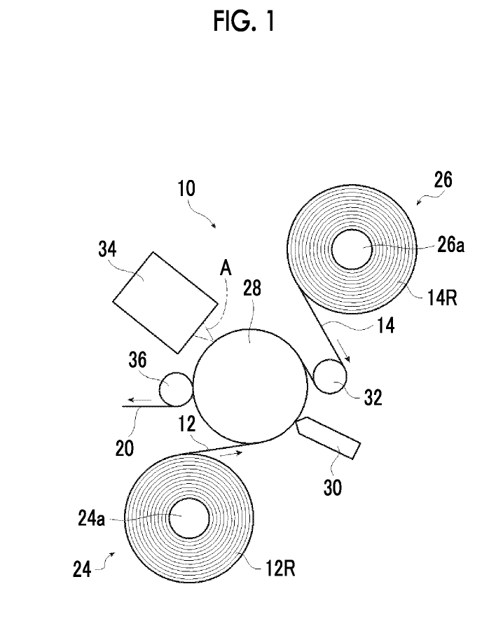

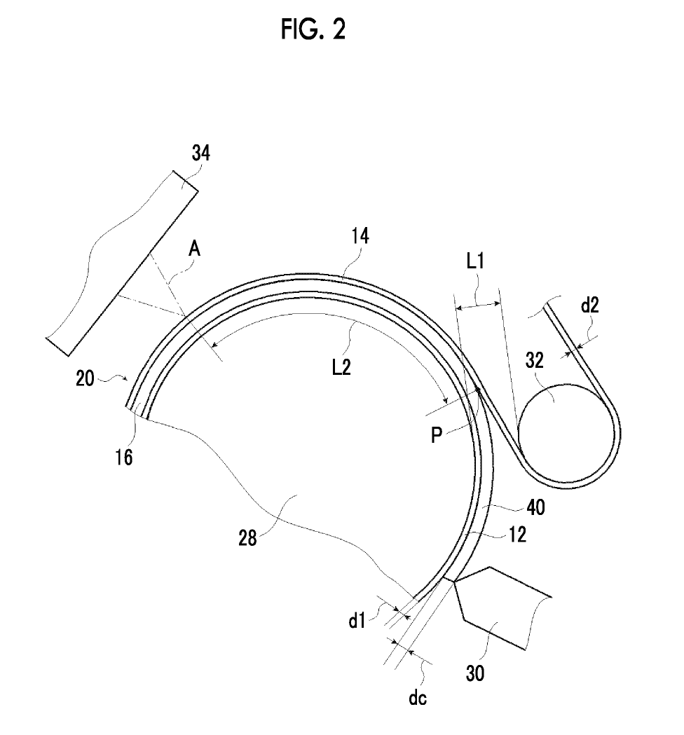

FIG. 1 schematically shows an example of the apparatus for manufacturing a laminated film of the present invention that is for performing the method for manufacturing a laminated film of the present invention. FIG. 2 is a partially enlarged view of FIG. 1.

A manufacturing apparatus 10 of a laminated film shown in FIG. 1 is for manufacturing a laminated film 20 obtained by sandwiching a cured layer 16 between a first film 12 and a second film 14.

The manufacturing apparatus 10 illustrated in the drawing is basically constituted with a first supply portion 24 that supplies the first film 12, a second supply portion 26 that supplies the second film 14, a backup roller 28, a coating device 30, a bonding roller 32, a curing device 34, and a peeling roller 36.

The manufacturing apparatus 10 is a manufacturing apparatus adopting so-called roll-to-roll processing in which a film is sent from a roll formed by rolling up a long film (sheet-like substance), a treatment such as film formation is performed in a state where the film is being transported in a longitudinal direction, and the film having undergone the treatment is rolled up.

Specifically, in the manufacturing apparatus 10, in a state where the first film 12 is being sent from the first supply portion 24, wound around the backup roller 28, and transported in a longitudinal direction, first, the surface of the first film 12 is coated with a coating solution (paint/coating composition) by the coating device 30, thereby forming a coating film 40. Then, the second film 14 is sent from the second supply portion 26 and laminated on the surface of the coating film 40. Thereafter, an actinic ray A is radiated from the curing device 34 such that the coating film 40 sandwiched between the first film 12 and the second film 14 is cured and formed into a cured layer 16. In this way, a laminated film 20 is manufactured.

In the manufacturing method and the manufacturing apparatus of a laminated film of the present invention, all of the coating film forming step of forming the coating film 40 on the surface of the first film 12, the laminating step of laminating the second film 14 on the coating film 40, and the curing step of curing the coating film 40 sandwiched between the first film 12 and the second film 14 are performed in a state where the first film 12 is being wound around the backup roller 28 and transported in a longitudinal direction.

As described above, the first supply portion 24 is a portion supplying the first film 12 to the backup roller 28.

The first supply portion 24 has a rotation shaft 24a. On the rotation shaft 24a, a first film roll 12R obtained by rolling up the long first film 12 is loaded.

In the first supply portion 24, by rotating the rotation shaft 24a, the first film 12 is sent from the first film roll 12R. The first film 12 sent from the first supply portion 24 is wound around the backup roller 28 and is transported along a predetermined path.

The first film 12 including a region wound around the backup roller 28, a laminate of the first film 12 and the coating film 40, a laminate of the first film 12, the coating film 40, and the second film, and the laminated film 20 may be transported by known methods.

In the present invention, as the first film 12 and the second film 14, it is possible to use various films (sheet-like substances) used in known laminated films.

Examples thereof include resin films formed of resin materials such as polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, a polymethyl methacrylate resin (PMMA), polycarbonate (PC), polyacrylate, polymethacrylate, polypropylene (PP), polystyrene (PS), an acrylonitrile.butadiene.styrene copolymer (ABS), a cycloolefin copolymer (COC), a cycloolefin polymer (COP), and triacetyl cellulose (TAC).

It is preferable that at least one of the first film 12 or the second film 14 is a gas barrier film.

Examples of the gas barrier film include those obtained by forming a gas barrier layer exhibiting gas barrier properties on the surface of a support. Among these, a gas barrier film is suitably used which is obtained by forming one or more combinations, each consisting of an inorganic layer exhibiting gas barrier properties as a gas barrier layer and an organic layer which becomes an underlayer of the inorganic layer.

Examples of the gas harrier layer or the inorganic layer exhibiting gas barrier properties suitably include layers formed of silicon nitride, silicon oxynitride, silicon oxide, aluminum oxide, and the like.

Examples of the organic layer which becomes an underlayer suitably include an acryl resin or a methacryl resin containing, as a main component, a polymer of a monomer or an oligomer of acrylate and/or methacrylate having two or more functional groups, particularly, three or more functional groups, such as dipropylene glycol di(meth)acrylate (DPGDA), trimethylolpropane tri(meth)acrylate (TMPTA), and dipentaerythritol hexa(meth)acrylate (DPHA).

In a case where a gas barrier film is used as the first film 12 and the second film 14, it is possible to prevent the cured layer 16 from deteriorating due to oxygen, moisture, and the like.

Considering the aforementioned point, an oxygen transmission rate of the first film 12 and the second film 14 is preferably 1×10⁻⁴ to 1 cm³(m².day.atm).

The oxygen transmission rate can be measured, for example, using an oxygen gas transmission rate measuring device (Ox-TRAN 2/20 manufactured by MOCON, Inc.) under the condition of a temperature of 23° C. and a relative humidity of 90%.

It is preferable that at least one of the first film 12 or the second film 14 has a hardcoat layer.

The hardcoat layer means a layer which has scratch resistance and scratch hardness (pencil method) (based on the specification of Japanese Industrial Standards (JIS) K-5600 (1999)) of equal to or higher than H. The scratch hardness is preferably equal to or higher than 2H and particularly preferably equal to or higher than 3H.

The hardcoat layer can be formed by coating-drying-curing a composition (material forming a hardcoat layer) which contains a compound having an unsaturated double bond, a polymerization initiator, light-transmitting particles used if necessary, a fluorine-containing compound or a silicone-based compound, and an organic solvent.

Regarding the hardcoat layer, for example, paragraphs “0162” to “0189” in JP2014-170130A can be referred to, but the present invention is not limited thereto.

It is preferable that at least one of the first film 12 or the second film 14 has a light diffusion layer.

The light diffusion layer means a layer that scatters the light passing through the layer. The light diffusion layer can be formed by coating.drying.curing a coating solution containing light-transmitting particles, a component forming a matrix (monomers for a binder and the like), and an organic solvent.

Regarding the light diffusion layer, for example, paragraphs “0025” to “0089” in JP2009-258716A can be referred to, but the present invention is not limited thereto.

The thickness of the first film 12 and the second film 14 may be appropriately set according to the use of the laminated film 20 and the like. According to the examination conducted by the inventors of the present invention, from the viewpoint of effect of reducing the thickness of the laminated film 20 and preventing wrinkles, the thickness of the first film 12 and the second film 14 is preferably 10 to 100 μm, and more preferably 15 to 60 μm. The first film 12 and the second film 14 may have the same thickness or different thicknesses.

In the present invention, the first film 12 and the second film 14 may be the same as or different from each other.

That is, for example, the first film 12 and the second film 14 may be the same gas barrier film, the same resin film, different gas barrier films, different resin films, or a gas barrier film and a resin film.

Here, in the present invention, in any of the cases, at least the second film 14 needs to sufficiently transmit the actinic ray A radiated from the curing device 34.

As described above, the first film 12 sent from the first supply portion 24 is wound around the backup roller 28.

The backup roller 28 is, for example, a cylindrical member made of a metal, and rotates in a state where the first film 12 is being wound around the lateral surface of the cylinder.

Being wound around the backup roller 28 means a state where the first film 12 is coming into contact with the surface of the backup roller 28 at a certain wrap angle. Accordingly, while being continuously transported, the first film 12, the first film 12 with the coating film 40, or the first film 12 with the second film 14 moves in synchronization with the rotation of the backup roller 28.

As described above, in the present invention, all of the formation of the coating film 40 on the first film 12, the lamination of the second film 14 on the coating film 40, and the curing of the coating film 40 are performed in a state where the first film 12 is being wound around the backup roller 28. Accordingly, the first film 12 is wound around the backup roller 28, from at least a position on the upstream from the position where the coating film 40 is formed on the first film 12 to at least a position on the downstream from the position irradiated with the actinic ray A.

In the present invention, all of “upstream” and “downstream” mean the upstream and the downstream in the transport direction of the first film 12.

In a preferable aspect, the backup roller 28 includes built-in temperature control means for controlling the surface temperature of the backup roller 28. The temperature control means can use various known methods such as the circulation of a temperature control medium and a method of using a heater or cooling means.

At the time of manufacturing the laminated film 20, the surface temperature of the backup roller 28 is preferably controlled within a range of 15° C. to 55° C., and more preferably controlled within a range of 20° C. to 40° C.

In the present invention, after the coating film 40 is formed, the second film is laminated on the coating film 40, and then the coating film 40 is irradiated with the actinic ray A. In this way, the coating film 40 is cured and becomes the cured layer 16. At this time, the first film 12 or the second film 14 is likely to be deformed by being heated. In a case where the first film 12 or the second film 14 is deformed at the time of curing the coating film 40, due to the deformation, the thickness of the cured layer 16 changes, and hence the thickness unevenness occurs in the cured layer 16.

In a case where the temperature of the backup roller 28 is controlled to become equal to or lower than 55° C., it is possible to suitably prevent the first film 12 or the second film 14 from being deformed due to heating and to prevent the film thickness of the cured layer 16 from becoming uneven.

Furthermore, it is preferable that the temperature of the backup roller 28 is controlled to become equal to or higher than 15° C., because then the investment in cooling facilities or the running costs can be reduced.

The diameter of the backup roller 28 may be appropriately set according to the size of the manufacturing apparatus 10 and the like.

According to the examination conducted by the inventors of the present invention, considering the curling deformation of the laminated film, the facility costs, the rotational accuracy, and the like, the diameter of the backup roller is preferably 100 to 1,000 mm, and more preferably 200 to 500 mm.

In the manufacturing apparatus 10, in a state where the first film 12 is being wound around the backup roller 28 and transported in a longitudinal direction, first, a coating film forming step is performed in which the coating film 40 is formed by coating the surface of the first film 12 with a coating solution containing an actinic ray curable-type resin by the coating device 30 positioned facing the backup roller 28.

As the coating device 30, according to the coating solution used for coating, various known liquid coating devices can be used as long as the coating film 40 having an intended film thickness can be formed.

Examples thereof include coating devices performing coating by using a coating solution by a die coating method, a curtain coating method, a rod coating method, an air knife coating method, a roller coating method, a wire bar coating method, a gravure coating method, a slide coating method, and the like.

The film thickness of the coating film 40 may be appropriately set according to the film thickness of the cured layer 16. The film thickness of the cured layer 16 may be appropriately set according to the use of the laminated film 20, the material forming the cured layer 16, the action of the cured layer 16, the performance required for the cured layer 16, and the like.

According to the examination conducted by the inventors of the present invention, the film thickness of the coating film 40 is preferably 10 to 80 μm.

The coating solution which becomes the coating film 40, that is, the cured layer 16 contains an actinic ray curable-type resin.

The actinic ray curable-type resin refers to a resin cured through a cross-linking reaction and a polymerization reaction by being irradiated with an actinic ray. The actinic ray refers to an electromagnetic wave such as an ultraviolet ray, an electron beam, and radiation (an α-ray, a β-ray, a γ-ray, and the like).

As the actinic ray curable-type resin, for example, resins having a photopolymerizable functional group of a polyfunctional monomer or a polyfunctional oligomer that can be cured by light (ultraviolet ray), an electron beam, and radiation are used. Among these, the photopolymerizable functional group is preferable. Examples of the photopolymerizable functional group include unsaturated polymerizable functional groups such as a (meth)acryloyl group, a vinyl group, a styryl group, and an allyl group, and the like.

As the solvent of the coating solution, for example, an organic solvent can be used. The organic solvent includes alcohols, ketones, esters, aliphatic hydrocarbons, amides, ethers, and ether alcohols. It is preferable to use two or more kinds of these solvents in combination, and it is more preferable to use three or more kinds of these solvents in combination.

The viscosity of the coating solution may be appropriately set according to the composition of the coating solution, the thickness of the coating film 40, and the like.

According to the examination conducted by the inventors of the present invention, in view of preventing the mingling of air bubbles and the uniformity of the thickness of the coating film 40, the viscosity of the coating solution is preferably 20 to 600 mPa·s and more preferably 40 to 400 mPa·s.

In addition to the actinic ray curable-type resin, substances performing various functions such as quantum dots, an organic electroluminescence material, an organic semiconductor material, a photoelectric conversion material, a thermoelectric conversion material, a dye, a pigment, and the like may be added to the coating solution.

Among these, quantum dots are suitably used.

The quantum dots refer to crystal particles having a nanoscale particle diameter that have optical characteristics resulting from a quantum confinement effect.

As the quantum dots, for example, quantum dots having a core-shell structure are known. Examples of the quantum dots having a core-shell structure represented by “core/shell” include CdSe/ZnS, CdSe/CdS, CdTe/CdS, InP/ZnS, GaP/ZnS, Si/ZnS, InN/GaN, and the like. Here, the structure of the quantum dots is not limited to the core-shell structure.

By changing the size of the quantum dots, the optical characteristics thereof can be changed. The smaller the particle diameter of the quantum dots, the stronger the light energy released by the quantum dots. Generally, the emission wavelength of the quantum dots can be adjusted by the composition and size of the particles.

Regarding the quantum dots, for example, paragraphs “0060” to “0066” in JP2012-169271A can be referred to, but the present invention is not limited thereto.

Instead of the quantum dots, quantum rods may also be used. The quantum rods refer to long thin particles having the same characteristics as those of the quantum dots.

As the quantum dots, commercially available products can be used without any restriction.

Furthermore, the quantum dots and the quantum rods can be simultaneously used.

The laminated film in which the cured layer 16 contains at least one of the quantum dots or the quantum rods is referred to as a quantum dot film as well.

On the downstream of the coating device 30, the bonding roller 32 for laminating the second film 14 on the coating film 40 is disposed facing the backup roller 28.

In the manufacturing apparatus 10, during the laminating step, the laminate obtained by forming the coating film 40 on the surface of the first film 12 is then transported to a laminating position P where lamination is performed by the bonding roller 32, and the second film 14 supplied from the second supply portion 26 is wound around the bonding roller 32, guided along a predetermined transport path, and laminated on the coating film 40.

The second supply portion 26 has a rotation shaft 26a. On the rotation shaft 26a, a second film roll 14R obtained by rolling up the long second film 14 is loaded.

By rotating the rotation shaft 26a in the second supply portion 26, the second film 14 is sent from the second film roll 14R. The second film 14 sent from the second supply portion 26 is wound around the bonding roller 32, transported along a predetermined path, and laminated on the coating film 40 in the laminating position P.

In the manufacturing apparatus 10 illustrated in the drawing, a distance L1 which is the shortest distance between the surface of the backup roller 28 and the surface of the bonding roller 32 is equal to or greater than the sum of a thickness d1 of the first film 12, a thickness dc of the coating film 40, and a thickness d2 of the second film. In the following description, the distance L1 will be referred to as “distance L1 between the backup roller 28 and the bonding roller 32” as well.

That is, “L1≥d1+dc+d2” is satisfied.

In other words, in a state of being wound around the bonding roller 32, the second film 14 does not come into contact with the coating film 40, that is, the second film 14 is not wound around the bonding roller in the laminating position P.

Because the manufacturing apparatus 10 has the aforementioned constitution, it is possible to extremely gently and lightly laminate the second film 14 on the coating film 40 without pressing the bonding roller 32 on the coating film 40 and pressing the second film 14 on the coating film 40. Accordingly, even though the second film 14 is laminated on the coating film 40, it is possible to prevent the film thickness of the coating film 40 from changing due to the lamination of the second film 14.

Therefore, according to the manufacturing apparatus 10, in a case where the coating film 40 having an intended film thickness and a uniform film thickness is highly accurately formed by the coating device 30, it is possible to prepare the cured layer 16 having an intended film thickness and a uniform film thickness.

In the manufacturing apparatus 10, basically only “L1≥d1+dc+d2” needs to be satisfied. However, the distance L1 is preferably less than “d1+dc+d2+5 cm”. That is, it is preferable that “L1<d1+dc+d2+5 cm” is satisfied.

The distance L1 preferably approximately equals “d1+dc+d2”, and most preferably satisfies “L1=d1+dc+d2”.

In order to appropriately transport the second film 14, a certain degree of tension needs to be applied to the second film 14.

In the manufacturing apparatus 10, between the bonding roller 32 and the laminating position P, the second film 14 is floating in the air without being supported with something. Therefore, in the region where the film is floating in the air, due to the tension applied to the second film 14, the second film 14 undergoes wavy deformation in the width direction thereof. The width direction is in other words a direction orthogonal to the transport direction.

In the manufacturing apparatus 10, the second film 14 can be laminated on the coating film 40 without affecting the coating film 40. However, the wavy deformation of the second film 14 can cause the film thickness of the coating film 40 to become uneven.

In contrast, in a case where “L1<d1+dc+d2+5 cm” is satisfied, the wavy deformation of the second film 14 can be reduced, and hence the film thickness unevenness of the coating film 40 resulting from the deformation of the second film 14 can be prevented.

In the present invention, the tension applied to the second film 14 is preferably equal to or lower than 100 N/m, and more preferably equal to or lower than 50 N/m.

In order to appropriately transport the second film 14, a certain degree of tension needs to be applied to the second film 14. Accordingly, due to the tension, the second film 14 may be pressed on the coating film 40, and hence the film thickness of the coating film 40 is likely to change.

In contrast, in a case where the tension applied to the second film 14 is set to be equal to or lower than 100 N/m, it is possible to prevent the tension applied to the second film 14 from affecting the film thickness of the coating film 40 and to obtain a laminated film in which the thickness unevenness of the cured Layer 16 is reduced.

In the present invention, provided that a tension applied to the first film 12 is T1; a Young's modulus of the first film in the transport direction is E1; a thickness of the first film 12 is d1; a tension applied to the second film 14 is T2; a Young's modulus of the second film 14 in the transport direction is E2; and a thickness of the second film 14 is d2, T1, E1, d1, T2, E2, and d2 preferably satisfy Expression 0.05<[T2/(E2×d2)]/[T1/(E1×d1)]<20, and more preferably satisfy Expression 0.1<[T2/(E2×d2)]/[T1/(E1×d1)]<10.

In the present invention, in a state where the first film 12 is being wound around the backup roller 28, the coating film 40 is cured and becomes the cured layer 16. Accordingly, the laminated film 20 is easily curled having the first film 12 as the inside thereof. The curling can also be prevented by controlling the tension applied to the first film 12 or the second film 14 and the like. However, in a case where the tension is not easily controlled, sometimes the laminated film 20 is curled having the second film 14 as the inside thereof in reverse.

In contrast, in a case where 0.05<[T2/(E2×d2)]/[T1/(E1×d1)]<20 is satisfied, it is possible to manufacture the laminated film 20 in which the curling that occurs in a state where the first film 12 becomes the inside and the curling that occurs in a state where the second film 14 becomes the inside are significantly relieved. Particularly, in a case where 0.1<[T2/(E2×d2)]/[T1/(E1×d1)]<10 is satisfied, it is possible to manufacture a high-quality laminated film 20 in which curling is more significantly relieved.

It is preferable that the rotational accuracy of the backup roller 28 and the bonding roller 32 is high. The radial run-out of the backup roller 28 and the bonding roller 32 is preferably equal to or smaller than 0.05 mm, and more preferably equal to or smaller than 0.01 mm.

In a case where the rotational accuracy of the backup roller 28 and the bonding roller 32 is within the above range, the film thickness distribution of the coating film 40 can be further narrowed.

On the downstream of the bonding roller 32, the curing device 34 is disposed facing the backup roller 28.

In a state of being wound around the backup roller, the laminate of the first film 12, the coating film 40, and the second film 14 in which the second film 14 is laminated on the coating film 40 is transported to the curing device 34 performing the curing step. The curing device 34 irradiates the coating film 40 sandwiched between the first film 12 and the second film 14 with the actinic ray A such that the coating film 40 is cured and becomes the cured layer 16, thereby forming the laminated film 20.

As described above, the actinic ray A is an electromagnetic wave such as an ultraviolet ray, an electron beam, and radiation (an α-ray, a β-ray, a γ-ray, and the like).

As the curing device 34, it is possible to use various devices using known light sources radiating the actinic ray A that can cure the coating film 40. In the example illustrated in the drawing, the curing device 34 uses a light source radiating an ultraviolet ray. As the light source radiating an ultraviolet ray, it is possible to use various known light sources. Examples thereof include a light emitting diode (LED), a laser light source, a low-pressure mercury lamp, a medium-pressure mercury lamp, a high-pressure mercury lamp, an ultrahigh-pressure mercury lamp, a carbon arc lamp, a metal halide lamp, a xenon lamp, and the like.

In the present invention, it is preferable that the actinic ray A has a peak of an intensity distribution in a wavelength range in which the coating film 40 can be cured. The actinic ray A is preferably an electromagnetic wave having a half-width of an intensity distribution (peak) with respect to a wavelength of equal to or smaller than 100 nm, and is more preferably an electromagnetic wave having the half-width of equal to or smaller than 50 nm.

That is, it is preferable that the curing device 34 uses a light source such as LED or a laser light source radiating the actinic ray A which has a peak of an intensity distribution in a wavelength range in which the coating film 40 can be cured and has a half-width of an intensity distribution (peak) with respect to a wavelength of equal to or smaller than 100 nm.

In the present invention, by irradiating the coating film 40 sandwiched between the first film 12 and the second film 14 with the actinic ray A, the coating film 40 is cured. Because the actinic ray A is also absorbed into the first film 12 and the second film 14, the first film 12 and the second film 14 are likely to be heated and deformed. In a case where the first film 12 or the second film 14 is deformed at the time of curing the coating film 40, due to the deformation, the thickness of the cured layer 16 changes, and the thickness of the cured layer 16 becomes uneven.

In contrast, in a case where the electromagnetic wave having a half-width of equal to or smaller than 100 nm is used as described above, it is possible to prevent the first film 12 and the second film 14 from being heated by an electromagnetic wave which is an unnecessary component not making a contribution to the curing of the coating film 40. Consequently, it is possible to prevent the film thickness of the cured layer 16 from becoming uneven due to the deformation of the first film 12 or the second film 14 resulting from heating.

The irradiation amount of the actinic ray A radiated from the curing device 34 may be appropriately set according to the transport rate of the first film 12, the film thickness of the coating film 40, and the like, such that the coating film 40 can be reliably cured.

According to the examination conducted by the inventors of the present invention, the irradiation amount of the actinic ray A radiated from the curing device 34 is preferably 100 to 10,000 mJ/cm², and more preferably 1,000 to 4,000 mJ/cm².

It is preferable that the irradiation amount of the actinic ray A is equal to or greater than 100 mJ/cm², because then the coating film 40 can be stably and appropriately cured.

Furthermore, it is preferable that the irradiation amount of the actinic ray A is equal to or smaller than 10,000 mJ/cm², because then the first film 12 and time second film 14 can be prevented from being heated by an excess of actinic ray A.

A distance L2 between the laminating position P and the position irradiated with the actinic ray A by the curing device 34 may be appropriately set according to the size of the backup roller 28, the film thickness of the coating film 40, the irradiation amount of the actinic ray A from the curing device 34, and the like.

The distance L2 between the laminating position P and the position irradiated with the actinic ray A by the curing device 34 is preferably equal to or greater than 30 mm, and more preferably equal to or greater than 50 mm.

It is preferable that the distance L2 is within the above range, because then the effect of leveling the coating film 40 on which the second film 14 is laminated is sufficiently obtained, and the film thickness distribution of the cured layer 16 can be excellent.

In the present invention, a difference between the temperature of the first film 12 and the second film 14 before the irradiation of the coating film 40 with the actinic ray A and the temperature of the first film 12 and the second film 14 after the irradiation of the coating film 40 with the actinic ray A is preferably equal to or lower than 25° C.

In a case where the temperature difference is equal to or lower than 25° C., it is possible to prevent the first film 12 and the second film 14 from being wrinkled.

On the downstream of the curing device 34, the peeling roller 36 is disposed.

The laminated film 20 manufactured by forming the cured layer 16 by means of curing the coating film 40 is then peeled from the backup roller 28 by the peeling roller 36, transported along a predetermined transport path, and wound around a winding shaft not shown in the drawing. In this way, a roll obtained by rolling up the laminated film 20 is formed.

Hereinafter, the method for manufacturing a laminated film of the present invention and the manufacturing of a laminated film will be more specifically described by explaining the action of the manufacturing apparatus 10 shown in FIGS. 1 and 2.

First, the first film 12 is drawn from the first film roll 12R, wound around the backup roller 28, and transported along a predetermined transport path reaching the winding shaft through the peeling roller 36. Furthermore, the second film 14 is drawn from the second film roll 14R, passed through the bonding roller 32, wound around the, backup roller 28, and transported along a predetermined path reaching the winding shaft through the peeling roller 36.

In addition, the coating device 30 is filled with a coating solution which becomes the coating film 40, that is, the cured layer 16.

Then, in order for the first film 12 and the second film 14 to be transported at a predetermined rate, the first film roll 12R, the second film roll 14R, the backup roller 28, the bonding roller 32, the peeling roller 36, and the winding shaft not shown in the drawing are synchronously rotated, thereby starting the transport of the first film 12 and the second film 14.

Then, the operation of the coating device 30 and the curing device 34 is started.

In a state of being wound around the backup roller 28, the first film 12 sent from the first film roll 12R is continuously transported in a longitudinal direction. In this state, the first film 12 is coated with a paint by the coating device 30, and as a result, the coating film 40 is formed on the surface of the first film 12.

The laminate in which the coating film 40 is formed on the surface of the first film 12 is then transported to the laminating position P. In a state of being wound around the backup roller 28, the laminate is continuously transported in a longitudinal direction. In this state, in the laminating position P, the second film 14 sent from the second film roll 14R is laminated on the coating film 40 by the bonding roller 32.

The laminate in which the coating film 40 is sandwiched between the first film 12 and the second film 14 is then transported to the curing device 34. In a state of being wound around the backup roller 28, the laminate is continuously transported in the longitudinal direction. In this state, the laminate is irradiated with the actinic ray A by the curing device 34. As a result, the coating film 40 sandwiched between the first film 12 and the second film 14 is cured, and the cured layer 16 is formed. In this way, the laminated film 20 is prepared.

The laminated film 20 prepared by the formation of the cured layer 16 is peeled from the backup roller 28 by the peeling roller 36, transported along a predetermined transport path, and wound around the winding shaft.

As described above, in the present invention, during the manufacturing of the laminated film 20 in which the cured layer 16 is sandwiched between the first film 12 and the second film 14, all of the formation of the coating film 40 by coating the first film 12 with the coating solution, the lamination of the second film 14 on the coating film 40, and the curing of the coating film 40 sandwiched between the first film 12 and the second film 14 are performed in a state where the first film 12 is being wound around the backup roller 28.

Accordingly, it is possible to prevent the film thickness of the coating film 40 from becoming uneven, and to manufacture a high-quality laminated film 20 in which the film thickness of the cured layer 16 is highly uniform.

As described in JP1998-114041A (JP-H10-114041A) and JP2011-225002A, in the related art, at the time of manufacturing a laminated film, a first film is coated with a coating solution while being transported in a state of being sandwiched between a pair of rollers and the like. As it is well known, in order to appropriately transport the first film, a certain degree of tension needs to be applied to the first film.

The first film on which a coating film is formed by being coated with the coating solution is not being supported with something and is floating in the air. Accordingly, in the region where the film is floating in the air, due to the tension applied to the first film 12, the first film 12 undergoes wavy deformation in the width direction thereof.

In a case where the first film 12 is deformed, the coating solution forming the coating film flows in response to the deformation. As a result, by the flowing of the coating solution, the film thickness of the coating film changes, and the film thickness of the coating film becomes uneven. In a case where the coating film having uneven film thickness is cured, naturally, the film thickness of the formed cured layer becomes uneven as well.

Therefore, with the manufacturing process of a laminated film of the related art, it is difficult to manufacture a laminated film including a cured layer having a highly uniform film thickness.

In contrast, in the present invention, as described above, all of the formation of the coating film 40 on the first film 12, the lamination of the second film 14 on the coating film 40, and the curing of the coating film 40 sandwiched between the first film 12 and the second film 14 are performed in a state where the first film 12 is being wound around the backup roller 28.

Accordingly, the first film 12 is supported with the backup roller 28 all the time and does not undergo wavy deformation. Consequently, it is possible to prevent the film thickness of the coating film 40, that is, the film thickness of the cured layer 16 from becoming uneven due to the deformation of the first film 12.

In addition, in the present invention, both the coating film 40 and the second film 14 are supported with the backup roller 28 all the time. Accordingly, it is possible to prevent the deformation of the coating film 40 and the second film 14, and to prevent the film thickness of the cured layer 16 from becoming uneven due to the deformation of the coating film 40 and the second film 14.

Consequently, according to the present invention, it is possible to stably manufacture a high-quality laminated film 20 including the cured layer 16 having a highly uniform film thickness.

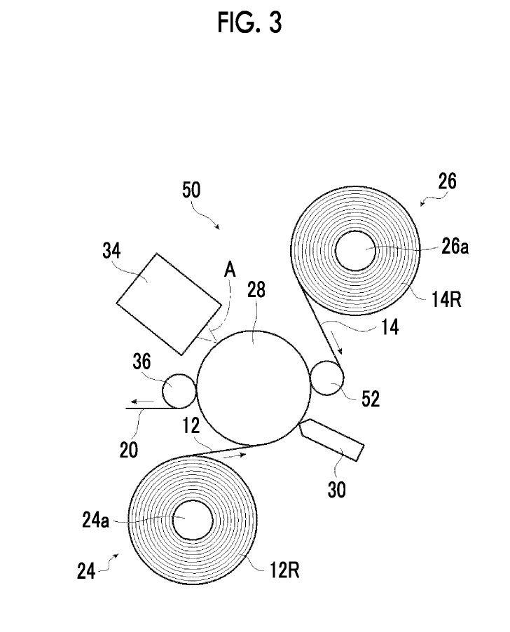

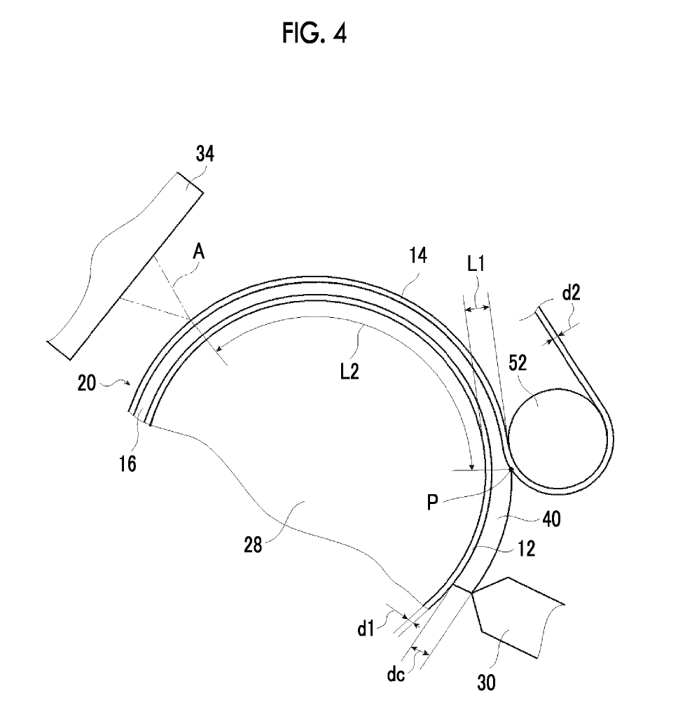

FIG. 3 schematically shows an example of another aspect of the manufacturing apparatus of the present invention. FIG. 4 is a partially enlarged view of FIG. 3.

A manufacturing apparatus 50 shown in FIGS. 3 and 4 has the same constitution as that of the aforementioned manufacturing apparatus 10, except that the positional relationship between a bonding roller 52 and the backup roller 28 is different. Accordingly, the same members are marked with the same references, and the difference will be mainly described below.

In the aforementioned manufacturing apparatus 10, the distance L1 between the backup roller 28 and the bonding roller 32 is equal to or greater than the sum of the thickness d1 of the first film 12, the thickness dc of the coating film 40, and the thickness d2 of the second film. That is, as described above, “L1≥d1+dc+d2” is satisfied.

In contrast, in the manufacturing apparatus 50 shown in FIGS. 3 and 4, the distance L1 between the backup roller 28 and the bonding roller 32 is less than the sum of the thickness d1 of the first film 12, the thickness dc of the coating film 40, and the thickness d2 of the second film. That is, in the present aspect, “L1<d1+dc+d2” is satisfied.

In other words, in the manufacturing apparatus 50, the second film 14 comes into contact with the coating film 40 in a state of being wound around the bonding roller 32. That is, the second film 14 is wound around the bonding roller in the laminating position P.

Therefore, as being schematically shown in FIG. 4, in the laminating position P, by pressing the second film 14 on the coating film 40, the film thickness of the coating film 40 can be changed. That is, in the manufacturing apparatus 50, by controlling the distance L1 between the backup roller 28 and the bonding roller 32, the film thickness of the coating film 40 can be controlled.

The aforementioned manufacturing apparatus 10 shown in FIGS. 1 and 2 is used in a case where the coating film 40 having a uniform and intended film thickness can be formed with sufficient accuracy as necessary by the coating device 30.

In contrast, the manufacturing apparatus 50 shown in FIGS. 3 and 4 is suitably used in a case where the coating performed by the coating device 30 by using a coating solution cannot be controlled with high accuracy.

As described above, in the present invention, all of the formation of the coating film 40 on the first film 12 and the like are performed in a state where the first film 12 is being wound around the, backup roller 28. Therefore, in the laminating position P, the film thickness of the coating film 40 does not become uneven due to the deformation of the first film 12. Consequently, by pressing the second film 14, the film thickness of the coating film 40 can be controlled with extremely high accuracy.

In the manufacturing apparatus 50, at the time of laminating the second film 14 on the coating film 40, it is possible to prevent the air (gas) from being drawn into the space between the coating film 40 and the second film 14. That is, this aspect is suitably adopted in a case where the drawing of the air into the space between the coating film 40 and the second film 14 becomes an issue according to the constitution of the apparatus and the like.

In the manufacturing apparatus 50 of the present aspect, basically, according to the film thickness of the coating film 40 and an intended film thickness of the cured layer 16, only “L1<d1+dc+d2” needs to be satisfied.

In the manufacturing apparatus 50, as in the aforementioned manufacturing apparatus 10, the thickness of the coating film 40 may be appropriately set according to the film thickness of the cured layer 16 and the like. The film thickness of a preferable coating film 40 is also appropriately set in this way.

Furthermore, how much the thickness of the coating film 40 will be controlled may be appropriately set according to the film thickness of the cured layer 16, the accuracy of the film thickness of the coating film 40, the film thickness of the coating film 40 whose thickness is not yet being controlled, and the like.

Hitherto, the method for manufacturing a laminated film of the present invention and the apparatus for manufacturing a laminated film of the present invention have been specifically described. It goes without saying that the present invention is not limited, to the examples described above, and may be ameliorated or modified in various ways within a scope that does not depart from the gist of the present invention.

### EXAMPLES

Hereinafter, the present invention will be more specifically described based on specific examples of the present invention. However, the present invention is not limited to the examples, and the materials, the amount and proportion of the materials used, the treatment content, the treatment procedure, and the like shown in the following examples can be appropriately modified as long as the gist of the present invention is not impaired.

### Example 1

As the first film 12 and the second film 14, a PET film (manufactured by Toyobo Co., Ltd, COSMOSHINE A4300) having a thickness of 100 μm and a width of 1,000 mm was prepared.

Furthermore, as a coating solution that the coating device used for coating, the following coating solution was prepared.

(Composition of Coating Solution)

Toluene dispersion liquid of quantum dot I (emission maximum: 520 nm) 10 parts by mass

Toluene dispersion liquid of quantum dot (emission maximum: 630 nm) 1 part by mass

Lauryl methacrylate 2.4 parts by mass

Trimethylolpropane triacrylate 0.54 parts by mass

Photopolymerization initiator (IRGACURE 819, manufactured by BASF SE) 0.009 parts by mass

As the quantum dots 1 and 2, the following nanocrystals having a core-shell structure (InP/ZnS) were used.

Quantum dot 1: INP530-10 (manufactured by NN-LABS, LLC.)

Quantum dot 2: INP620-10 (manufactured by NN-LABS, LLC.)

By using an EMS viscometer (manufactured by KYOTO ELECTRONICS MANUFACTURING CO., LTD.), the viscosity of the coating solution was measured at a shear rate of 0.1/s. As a result, the viscosity of the prepared coating solution was 50 mPa·s.

By using the first film 12, the second film 14, and the coating solution, the laminated film 20 was prepared by the manufacturing apparatus 10 shown in FIG. 1.

The backup roller 28 included built-in temperature control means, had a diameter of 200 mm, and was made of stainless steel. The surface temperature thereof was controlled to become 25° C.

The transport rate of the first film 12 was set to be 1 m/min, and the tension applied to the first film 12 and the second film 14 was set to be 100 N/m.

The film thickness of the coating film 40 was set to be 70 μm. Accordingly, in the present example, the thickness of the cured layer 16 was approximately 70 μm.

The distance L1 between the backup roller and the bonding roller was set to be 10 mm.

In the curing device 34, an LED (manufactured by SENTECH, UV-LED 233A) radiating an ultraviolet ray having a central wavelength of 365 nm and a half-width of 10 nm was used as a light source. The irradiation amount of the ultraviolet ray was set to be 900 mJ/cm².

[T2/(E2×d2)]/[T1/(E1×d1)] equaled 1.

### Comparative Example 1

A laminated film was prepared in the same manner as in Example 1, except that the lamination of the second film 14 and the curing of the coating film were performed in a state where the first film 12 was peeled from the backup roller 28 and then transported while being sandwiched between a pair of rollers separately disposed on the downstream of the backup roller 28.

### Examples 2 and 3

As a light source of the curing device 34, instead of the LED, a metal halide lamp (manufactured by EYE GRAPHICS Co., Ltd., M30-L51X) radiating an ultraviolet ray having a central wavelength of 365 nm was used. The main emission wavelength of this light source is in a range of 200 to 450 nm, and hence the width of the emission wavelength of the light source is large. Therefore, the half-width thereof is greater than 100 nm.

### Example 2

By using the aforementioned light source, the laminated film 20 was prepared in the same manner as in Example 1, except that the irradiation amount of the ultraviolet ray was set to be 900 mJ/cm², and the surface temperature of the backup roller 28 was set to be 55° C.

### Example 3

By using the aforementioned light source, the laminated film 20 was prepared in the same manner as in Example 1, except that the irradiation amount of the ultraviolet ray was set to be 50 mJ/cm², and the surface temperature of the backup roller 28 was set to be 25° C.

### Examples 4 to 8

### Example 4

The laminated film 20 was prepared in the same manner as in Example 1, except that the tension of the second film 14 was set to be 10 N/m.

[T2/(E2×d2)]/[T1/(E1×d1)] equaled 0.1,

### Example 5

The laminated film 20 was prepared in the same manner as in Example 1, except that the tension of the second film 14 was set to be 200 N/m.

[T2/(E2×d2)]/[T1/(E1×d1)] equaled 2.

### Example 6

The laminated film 20 was prepared in the same manner as in Example 1, except that the tension of the second film 14 was set to be 1,000 N/m.

[T2/(E2×d2)]/[T1(E1×d1)] equaled 10.

### Example 7

The laminated film 20 was prepared in the same manner as in Example 1, except that the tension of the second film 14 was set to be 5 N/m.

[T2/(E2×d2)]/[T1/(E1×d1)] equaled 0.05.

### Example 8

The laminated film 20 was prepared in the same manner as in Example 1, except that the tension of the first film 12 was set to be 50 N/m, and the tension of the second film 14 was set to be 1,000 N/m.

[T2/(E2×d2)]/[T1/(E1×d1)] equaled 20.

### Example 9

The laminated film 20 was prepared in the same manner as in Example 1, except that the manufacturing apparatus 50 shown in FIGS. 3 and 4 was used in which the distance L1 between the backup roller and the bonding roller was 260 μm.

Accordingly, in this example, the thickness of the cured layer 16 was 60 μm.

### Comparative Example 2

A laminated film was prepared in the same manner as in Example 1, except that the coating of the first film 12 with the coating solution was performed before the first film 12 was wound around the backup roller.

[Curling of Film]

For the prepared laminated film, the radius of a curl was measured, thereby evaluating the curling of the film.

In the evaluation, in a case where the radius of a curl was greater than 500 mm, the laminated film was graded A; in a case where the radius of a curl was greater than 50 mm and equal to or smaller than 500 mm, the laminated film was graded B; and in a case where the radius of a curl was equal to or smaller than 50 mm, the laminated film was graded C.

[Thickness Unevenness]

The film thickness of the prepared laminated film was measured using a contact-type thickness measurement device (manufactured by Yamabun Electronics Co., Ltd., TOF5R), and the film thickness of the first film 12 and the second film 14 was subtracted from the measured film thickness of the laminated film, thereby measuring the film thickness of the cured layer 16.

The film thickness of the cured layer 16 was measured at 1,000 spots at an interval of 1 mm in the transport direction of the film and in a direction orthogonal to the transport direction of the film, and from the minimum film thickness and the maximum film thickness with respect to the average film thickness, the thickness unevenness was calculated. The direction orthogonal to the transport direction of the film is in other words the width direction of the film.

In the evaluation, in a case where the thickness unevenness was less than ±2%, the laminated film was graded A; in a case where the thickness unevenness was equal to or higher than ±2% and less than ±3%, the laminated film was graded B; and in a case where the thickness unevenness was equal to or higher than ±3%, the laminated film was graded C.

The results are shown in the following table.

TABLE 1

| | Film tension | | | | | UV | | |
|---|---|---|---|---|---|---|---|---|
| | [N/m] | | | Roller | | irradiation | | |
| | First | Second | Tension | temperature | Light source | amount | | Thickness |
| | film | film | ratio | [° C.] | for curing | [mJ/cm²] | Curling | unevenness |
| Example 1 | 100 | 100 | 1 | 25 | LED | 900 | A | A |
| Comparative | 100 | 100 | 1 | 25 | LED | 900 | A | C |
| Example 1 | | | | | | | | |
| Example 2 | 100 | 100 | 1 | 55 | Metal halide | 900 | A | B |
| Example 3 | 100 | 100 | 1 | 25 | Metal halide | 50 | A | A |
| Example 4 | 100 | 10 | 0.5 | 25 | LED | 900 | B | A |
| Example 5 | 100 | 200 | 2 | 25 | LED | 900 | A | B |
| Example 6 | 100 | 1000 | 4 | 25 | LED | 900 | B | B |
| Example 7 | 100 | 5 | 0.05 | 25 | LED | 900 | C | A |
| Example 8 | 50 | 1000 | 20 | 25 | LED | 900 | C | B |
| Example 9 | 100 | 100 | 1 | 25 | LED | 900 | A | A |
| Comparative | 100 | 100 | 1 | 25 | LED | 900 | A | C |
| Example 2 | | | | | | | | |

The tension ratio means [T2/(E2 × d2)]/[T1/(E1 × d1)].
The metal halide means a metal halide lamp.
The manufacturing apparatus 50 was used in Example 9, and the manufacturing apparatus 10 was used in all the other examples.

As shown in the above table, in Comparative Example 1 in which the lamination of the second film 14 and the curing of the coating film are performed in a state where the first film 12 is peeled from the backup roller 28 and in Comparative Example 2 in which the coating film was formed before the first film 12 is wound around the backup roller 28, the thickness unevenness of the cured layer is higher than 3%.

In contrast, according to the present invention in which all of the formation of the coating film, the lamination of the second film 14, and the curing of the coating film are performed in a state where the first film 12 is being wound around the backup roller 28, the thickness unevenness of the cured layer 16 can be suppressed. Particularly, as shown in Examples 1, 3, 4, 7, and 9, in a case where all of the conditions that the tension applied to the second film needs to be equal to or lower than 100 N/m, the half-width of the actinic ray curing the coating film 40 needs to be equal to or smaller than 100 nm, and the surface temperature of the backup roller 28 needs to be equal to or lower than 55° C. are satisfied, a laminated film including the cured layer 16 having extremely small film thickness unevenness, which is less than ±2%, is obtained. Even though the evaluation result of the thickness unevenness is “B”, because the thickness unevenness is less than ±3%, the laminated film is generally unproblematic for practical use.

Furthermore, as shown in Examples 1 to 6 and 9, in a case where 0.05<[T2/(E2×d2)]/[T1/(E1×d1)]<20 is satisfied, the curling of the laminated film can be significantly relieved. Particularly, as shown in Examples 1 to 3, 5, and 9, in a case where 0.1<[T2/(E2×d2)]/T1(E1×d1)<10 is satisfied, it is possible to obtain a laminated film undergoing extremely slight curling in which the radius of a curl is greater than 500 mm. Even though the evaluation result of curling is “B”, because the radius of a curl is greater than 50 mm, the laminated film is generally unproblematic for practical use. Furthermore, even though the evaluation result of curling is “C”, because the curling can be corrected by known methods, the laminated film is unproblematic for practical use.

The above results clearly show the effects of the present invention.

The present invention can be suitably used for manufacturing various laminated films such as a wavelength conversion film.

### EXPLANATION OF REFERENCES

10, 50: manufacturing apparatus (of laminated film)
12: first film
14: second film
16: cured layer
20: laminated film
24: first supply portion
26: second supply portion
28: backup roller
30: coating device
32, 52: bonding roller
34: curing device
36: peeling roller
40: coating film

What is claimed is:

1. A method for manufacturing a laminated film, comprising:
a coating film forming step of forming a coating film by coating a surface of a first film with a coating solution containing an actinic ray curable-type resin while continuously transporting the first film;
a laminating step of laminating a second film on the coating film while continuously transporting the second film; and
a curing step of curing the coating film by irradiating the coating film with an actinic ray while continuously transporting the coating film by sandwiching the coating film between the first film and the second film such that a cured layer is formed,
wherein all the coating film forming step, the laminating step, and the curing step are performed in a state where the first film is being wound around a backup roller.

2. The method for manufacturing a laminated film according to claim 1,
wherein in the laminating step, the second film is laminated on the coating film, in a state of being wound around a bonding roller separated from the first film.

3. The method for manufacturing a laminated film according to claim 2,
wherein a distance between the bonding roller and the backup roller is equal to or greater than the sum of a thickness of the first film, a thickness of the coating film, and a thickness of the second film.

4. The method for manufacturing a laminated film according to claim 2,
wherein a distance between the bonding roller and the backup roller is less than the sum of the thickness of the first film, the thickness of the coating film, and the thickness of the second film.

5. The method for manufacturing a laminated film according to claim 4,
wherein a gap between the backup roller and the bonding roller is controlled such that a film thickness of the coating film is controlled by the second film wound around the bonding roller.

6. The method for manufacturing a laminated film according to claim 1,
wherein a tension applied to the second film is equal to or lower than 100 N/m.

7. The method for manufacturing a laminated film according to claim 1,
wherein in the curing step, the actinic ray curing the coating film is an electromagnetic wave having a half-width of an intensity distribution with respect to a wavelength of equal to or smaller than 100 nm.

8. The method for manufacturing a laminated film according to claim 1,
wherein a surface temperature of the backup roller is controlled within a range of 15° C. to 55° C.

9. The method for manufacturing a laminated film according to claim 1,
wherein provided that a tension applied to the first film is T1, a Young's modulus of the first film in a transport direction is E1, a thickness of the first film is d1, a tension applied to the second film is T2, a Young's modulus of the second film in a transport direction is E2, and a thickness of the second film is d2, T1, E1, d1, T2, E2, and d2 satisfy the following expression.
0.05<[T2/(E2×d2)][T1/(E1×d1)]<20

10. An apparatus for manufacturing a laminated film, comprising:
a backup roller;
transport means for continuously transporting the first film by winding the first film around the backup roller;
coating film forming means which is disposed facing the backup roller and forms a coating film by coating the first film wound around the backup roller with a coating solution containing an actinic ray curable-type resin;
laminating means which is disposed facing the backup roller on a downstream side of the coating film forming means in a transport direction of the first roller and laminates the second film on the coating film while continuously transporting the second film; and
curing means which is disposed facing the backup roller on a downstream side of the laminating means in the transport direction of the first film and irradiates a laminate, in which the coating film is sandwiched between the first film and the second film, with an actinic ray.
